(19) United States
(12) Patent Application Publication
(10) Pub. No.: US 2017/0164294 A1
(43) Pub. Date: Jun. 8, 2017

(54) DIGITAL ENHANCED CORDLESS TELECOMMUNICATION CALL MANAGEMENT

(71) Applicants: Steven Dickinson, Edinburgh (GB); Nir Kalfus, Tel Mond (IL); Effi Shiri, Petah Tikva (IL)

(72) Inventors: Steven Dickinson, Edinburgh (GB); Nir Kalfus, Tel Mond (IL); Effi Shiri, Petah Tikva (IL)

(21) Appl. No.: 15/371,242

(22) Filed: Dec. 7, 2016

Related U.S. Application Data
(60) Provisional application No. 62/263,824, filed on Dec. 7, 2015.

(51) Int. Cl. H04W 52/04; H04W 72/04

(52) U.S. Cl. CPC H04W 52/04; H04W 72/0406

(57) ABSTRACT

To overcome the restriction on the number of handsets or portable parts that can be rung at any one time using the DECT protocol, the ULE B-field paging mechanism is used as a replacement for the DECT indirect link establishment scheme. ULE B-field paging is used to indicate the presence of an incoming call to multiple handsets, or handset groups. Also, the ULE Connectionless, (connectionless), downlink may be used to indicate other information. This information would include but not be limited to Caller ID, pending address book changes, and SMS message pending.

### RELATED APPLICAITONS

This application claims priority from U.S. provisional patent Ser. No. 62/263,824 filing date Dec. 7, 2016 which is incorporated herein by reference.

### BACKGROUND OF THE DISCLOSURE

Devices conforming to the Digital Enhanced Cordless Telecommunications (DECT) standard are used in both voice and data applications.

In a typical DECT system there is the fixed part, which functions as a base station, and multiple portable parts, which function as handsets.

FIG. 1 shows a typical DECT system 100 with one fixed part 110 and four portable parts 121, 122, 123 and 124. The DECT system as illustrated in FIG. 1 may represent a typical residential cordless telephone application where each of the portable parts 121, 122, 123 and 125 might be placed in different rooms in the residence. The fixed point 110 is coupled to the public switched telephone network (PSTN) 130.

FIG. 2 depicts a typical DECT office system 200 where there are many more portable parts in use. A central private branch exchange (PBX) 210 is used together with several remote fixed parts (RFP). Three RFPs 221, 222 and 223 are shown in FIG. 2. A relatively large number of portable parts 231, 232 and 233 are used throughput the office area and will be connected to one of the RFPs. For example, in FIG. 2 the portable parts 231 are connected to RFP 221, portable parts 232 are connected to RFP 222 and portable parts 233 are connected to RFP 223. It should be noted that each of the portable parts is mobile and can change the RFP to which it is connected as it roams throughput the office area.

The DECT standard defines a structure of frames with duration 10 ms each frame consisting of twenty-four timeslots. In addition, there are ten frequency carriers that can be used, resulting in two hundred and forty slot/carrier pairs.

The DECT slot and frame structure is shown in FIG. 3.

A multi-frame 301 has sixteen frames 302 and has duration of 160 ms. Each frame 302 has duration of 10 ms and has twenty-four slots 303.

Each slot 303 is 416.7 μs in duration and includes an S-field, an A- field, a B-field, two error check fields and a guard period. The frame 302 is split into two equal halves: slots 0 to 11 are used for the downlink fixed part to portable part transmission and slots 12-23 are used for the uplink portable part to fixed part transmission. The downlink and uplink slots are paired such that they are 5 ms apart. For example, if slot 2 is used for the downlink, then slot 14 would be used as the uplink.

With twenty-four slots a single fixed part could support twelve simultaneous duplex connections but in practice, in order to accommodate the required fast frequency changes between slots, the number of usable slots is often limited to twelve and the time between adjacent slots is used to change the radio frequency.

The DECT system operates using periodic transmissions on a particular slot/carrier pair. The periodic transmission is termed a “bearer”.

There are two types of bearers used in the DECT standard: dummy bearers, and traffic bearers. The dummy bearer is a simplex bearer transmitted by the fixed part and carries identity information and other data which a portable part requires in order to lock on to the fixed part. A traffic bearer is a duplex bearer transmitted by both a fixed part and a portable part and carries the signaling information and application data.

The DECT bearer timing is shown in FIG. 4. Within a series of frames 401 the dummy bearer 411 is transmitted in the same downlink slot by the fixed part in each frame. The dummy bearer is therefore transmitted every 10 ms. The downlink traffic bearer 421 is transmitted in another downlink slot and the accompanying uplink traffic bearer 422 is transmitted 5 ms later in the corresponding uplink slot.

In order to ring a portable part for an incoming call a scheme known as “indirect link establishment” is used.

Each portable part is paged and a link is established. Information related to the call is sent over the link. This information, for example, may include “Caller ID” and the ringing cadence. When a portable part responds to the call, the audio path is connected.

Typically, it should be noted that every portable part connected to the fixed part will be caused to ring. For example, in the case of a residential system, the portable parts will be distributed throughout the residence and it is not known where the intended recipient is. Hence all the portable parts will ring and when one is picked up, the call is established with that specific portable part. Hence a link is required to each ringing handset. As previously explained, in practice there are only twelve usable slot pairs or six duplex connections. In addition, in most DECT systems one slot pair is reserved for handover actions and hence in general there is a practical limit of only five portable parts that can be rung at any one time. In the case of multiple handsets, only the handset that “off-hooks” is connected to the call, the other handsets will stop ringing when the call is answered (or the caller drops the call).

DECT also possesses a feature known as “Collective Ringing”, which is also known as “Group Ringing”, which can be used to ring handsets. In this case, the base station uses pages only to alert the handsets and in this case the handsets do not establish links with the base. Hence the number of ringing handsets is not limited by available slot-pairs. Only when the user answers the call, by “off-hook” on a handset, is a link with the base station established. Caller ID information can also be sent using Connection Less Messaging Service (CLMS). However, CLMS still uses paging over the “A-field” of the dummy bearer and this is a limited resource. “ULE” is an Ultra Low Power standard that is based on the DECT standard. ETSI TS 102 939-2 V1.1.1 (2015-03) “Digital Enhanced Cordless Telecommunications (DEST; Ultra Low Energy (ULE); Machine to Machine Communications; Part 2: Home Automation Network (phase 2)” is used as reference [1] in this disclosure.

ULE uses a special ULE dummy bearer which contains additional information in the “B-field” allowing hibernating handsets to gain synchronization very quickly in order to facilitate fast, low-latency data transfers. In addition, ULE also has a very flexible paging system, again using the “B-field”, which allows devices to be paged for various functions, including the ability to broadcast “connectionless” downlink data.

### SUMMARY

There may be provided a method for incoming call management, the method may include receiving an incoming call by a digital enhanced cordless telecommunications (DECT) fixed point; sending an incoming call indicator, using at least one out of ultra low energy (ULE) paging and ULE broadcast, by the DECT fixed point, to a group of DECT portable parts; wherein each member of the group of DECT portable parts was registered as a ULE device at the DECT fixed point; wherein the sending of the incoming call indicator may be executed without establishing a link with members of the group of DECT portable parts; receiving a setup request from a certain member of the group of DECT portable parts; establishing a link with the certain member; and directing the incoming call to the certain member.

The method further may include sending additional information to the group of group of DECT portable parts; and wherein the additional information differs from the incoming call indicator.

The additional information may include a caller identifier.

The additional information may include a textual message.

The additional information and the call indicator may be included in a single information bearer.

The additional information and the call indicator may be included in different bearers.

The sending of the additional information may include using ULE contactless downlink.

The method may include transmitting, by the DECT fixed point, a sequence of bearers that may include an additional information bearer and a dummy bearer.

The method may include repeating, multiple times, the sending of the incoming call indicator and the sending of the additional information.

The sending of the call indicator may include sending a broadcast identifier or a paging identifier to the group of DECT portable parts.

The sending of the incoming call indicator may include sending the call indicator within a B-field of a ULE dummy bearer.

There may be provided a non-transitory computer readable medium that stores instructions that once executed by a digital enhanced cordless telecommunications (DECT) fixed point, causes the DECT fixed point to receive an incoming call; send an incoming call indicator, using at least one out of ultra low energy (ULE) paging and ULE broadcast, to a group of DECT portable parts; wherein each member of the group of DECT portable parts was registered as a ULE device at the DECT fixed point; wherein the sending of the incoming call indicator may be executed without establishing a link with members of the group of DECT portable parts; receive a setup request from a certain member of the group of DECT portable parts; establish a link with the certain member; and direct the incoming call to the certain member.

There may be provided a digital enhanced cordless telecommunications (DECT) fixed point that may include a transceiver and a processor; wherein the transceiver may be configured to receive an incoming call by a DECT fixed point; wherein the processor may be configured to generate an incoming call indicator using at least one out of ultra low energy (ULE) paging resource and a ULE broadcast resource; wherein the transceiver may be configured to send the incoming call indicator to a group of DECT portable parts; wherein each member of the group of DECT portable parts was registered as a ULE device at the DECT fixed point; wherein the DCET fixed point may be configured to send the incoming call indicator without establishing a link with members of the group of DECT portable parts; wherein the transceiver may be configured to receive a setup request from a certain member of the group of DECT portable parts; wherein the DECT fixed point may be further configured to establish a link with the certain member and direct the incoming call to the certain member.

The transceiver may be configured to send additional information to the group of group of DECT portable parts; and wherein the additional information differs from the incoming call indicator.

The additional information may include a caller identifier.

The additional information may include a textual message.

The additional information and the call indicator may be included in a single information bearer.

The additional information and the call indicator may be included in different bearers.

The transceiver may be arranged to send the additional information by using ULE contactless downlink.

The transceiver may be arranged to send a sequence of bearers that may include an additional information bearer and a dummy bearer.

The DECT fixed point may be arranged to repeat, multiple times, a sending of the incoming call indicator and a sending of the additional information.

The transceiver may be configured to send a broadcast identifier or a paging identifier to the group of DECT portable parts.

The transceiver may be configured to send the call indicator within a B-field of a ULE dummy bearer.

### DESCRIPTION OF DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic drawing of a typical DECT system;

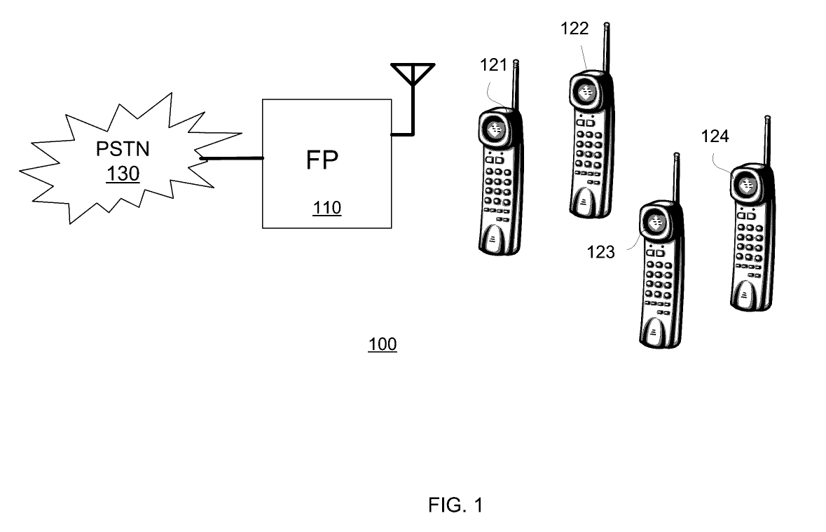

FIG. 2 is a schematic drawing of a typical DECT office system;

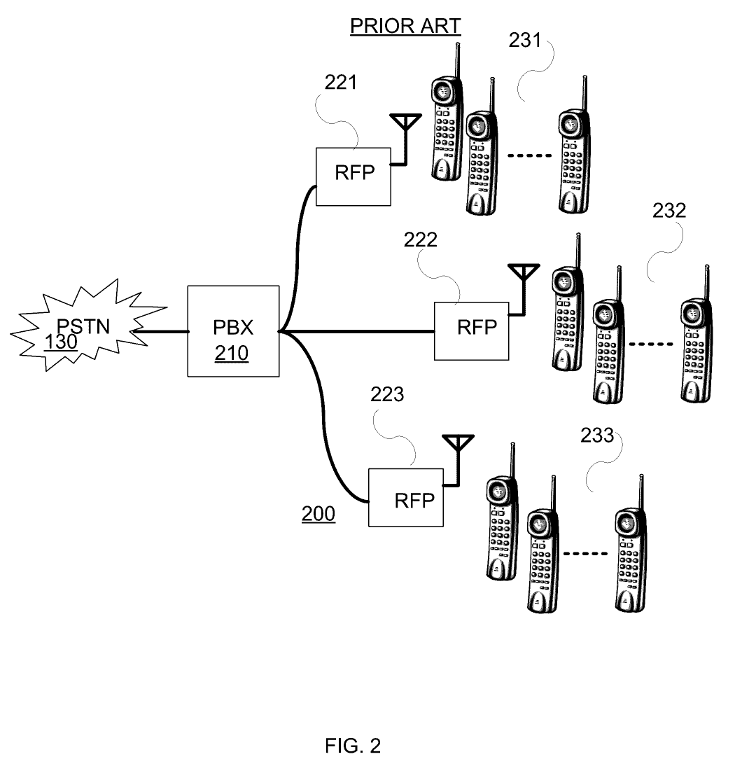

FIG. 3 is a diagram of the DECT slot and frame structure;

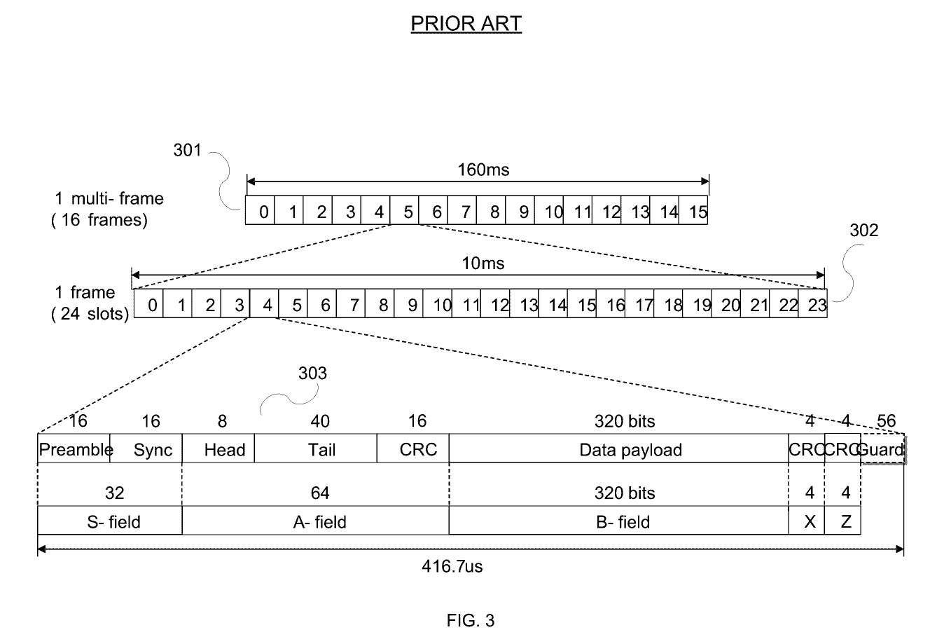

FIG. 4 is a diagram showing the DECT bearer timing;

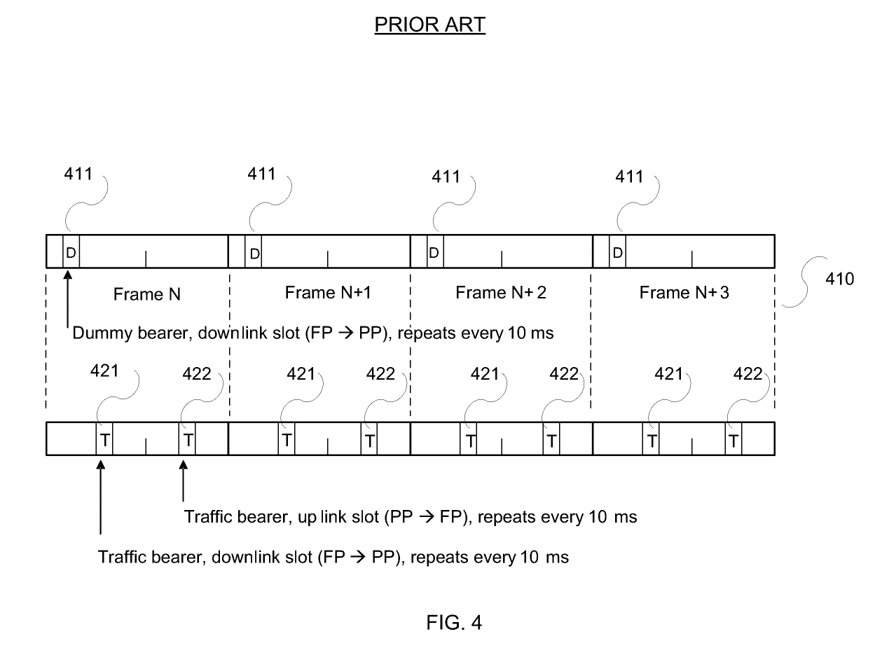

FIG. 5 is a timing diagram of the sequence of exchanges used to set up a call using ULE paging;

FIG. 6 illustrates a multi-frame; and

FIG. 7 illustrates a method.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device capable of executing the method and should be applied mutatis mutandis to a non-transitory computer readable medium that stores instructions that once executed by a computer result in the execution of the method.

Any reference in the specification to a device should be applied mutatis mutandis to a method that may be executed by the device and should be applied mutatis mutandis to a non-transitory computer readable medium that stores instructions that may be executed by the device.

Any reference in the specification to a non-transitory computer readable medium should be applied mutatis mutandis to a device capable of executing the instructions stored in the non-transitory computer readable medium and should be applied mutatis mutandis to method that may be executed by a computer that reads the instructions stored in the non-transitory computer readable medium.

“Ultra Low Energy” can be a device that may comply with technical Specification TS 102 939-01) or any other ULE related standard. A ULE transmission may, for example, exhibit an average transmission power of 10 mW (250 mW peak) in Europe and 4 mW (100 mW peak) in the US.

A fixed part DECT compliant fixed part and a portable part is a DECT compliant portable part.

To overcome the restriction on the number of handsets or portable parts that can be rung at any one time using the DECT protocol, a ULE paging mechanism and especially (but not limited to) a ULE B-field paging mechanism is used as a replacement for the DECT indirect link establishment scheme. ULE B-field paging is used to indicate the presence of an incoming call to multiple handsets, or handset groups.

The ULE connectionless (C/L) downlink may be used to indicate other information. This information would include but not be limited to Caller ID, pending address book changes, and SMS message pending.

When using the ULE B-Field paging, ULE paging descriptors are assigned. A ULE paging descriptor identifies a paging signal (by its sequence and paging ID) and defines the action to be performed when the signal appears. This is normally done after registration, but it can be any time. The fixed part assigns one or more ULE paging descriptors that tell the portable part which frame/multi-frame to listen to and which paging ID is used. Paging ID is a numeric value that combined with a sequence defines a paging signal. Paging IDs are numeric values between 0 and 511

Separate ULE paging descriptors may be assigned for voice calls (optionally) connectionless Downlink. These ULE paging descriptors then tell the portable part which frame/multi-frame combination is used and what ID they should listen for.

When the fixed part wants to page a portable part, or group of portable parts, using this mechanism it waits for the appropriate frame/multi-frame and then sets the appropriate “bit” in the paging field which relates to the assigned “paging ID”. For a detailed description see ETSI standard EN 300 175-3 v 2.6.1. [2] Section 9.5 Ultra Low Energy (ULE) Mode Procedures. Paging information is sent in Subfield 1 (clause 9.5.1.2 [2]) and Subfield 3 (clause 9.5.1.4 [2]). Alternatively, instead of using a ULE paging descriptor, a ULE broadcast descriptor can be used.

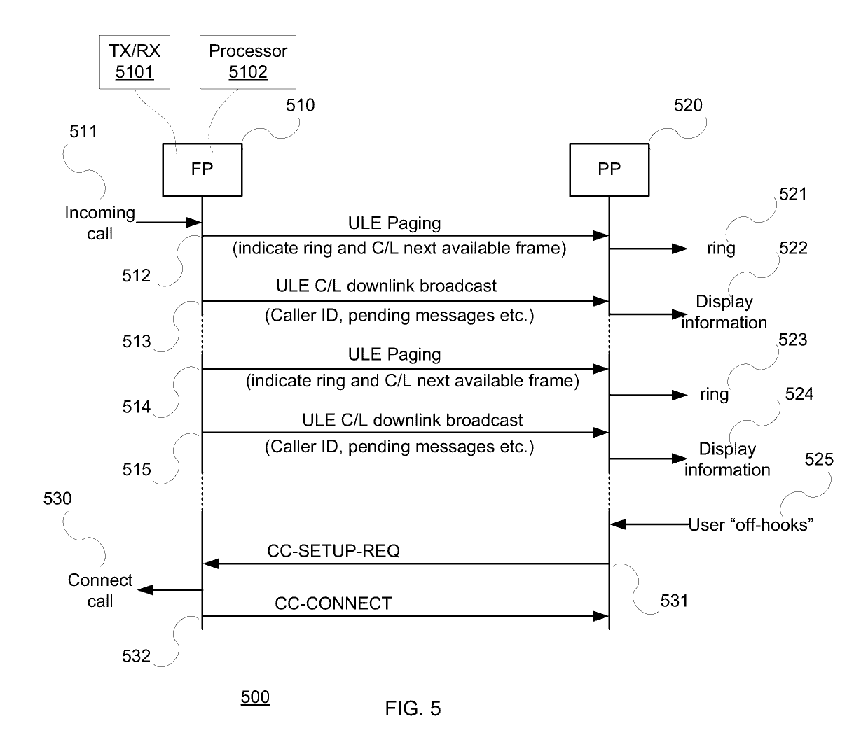

FIG. 5 is a timing diagram of the sequence of exchanges 500 used to set up a call using ULE paging.

The fixed part has a processor 5102 and a transceiver (denoted TX/RX 5101).

The process begins with an incoming call being received 511 by the fixed part 510.

The fixed part then indicates the ring 512 using ULE B-field paging.

This is received at the portable part 520 which then initiates 522 a ring.

In the next available frame, the fixed part 510 sends 513 the ULE connectionless downlink broadcast to the portable part 520. The ULE connectionless downlink broadcast may include additional information—information that differs from the call indicator.

Upon reception of the connectionless downlink broadcast, the portable part 520 may display 522 the additional information.

The downlink broadcast is typically directed at several portable parts.

The fixed part 510 may later send 514 another ULE B-field paging to the portable part 520 again causing the portable part 520 to ring 523.

The repetition of paging and connectionless data is for robustness. Paging is unacknowledged, so it is usually sent multiple times to ensure reception by the portable parts.

The ULE B-field paging could be sent more than twice, for example once every couple of seconds until the call is answered or dropped.

In case that the portable part 520 received duplicate pages for incoming calls, the portable part can understand that it is already ringing and so can ignore the second or subsequent repeats. The portable part may store an indication that the previous incoming call was not answered yet and is still ringing—and can ignore the repetitions.

The fixed part 510 may also send 515 another ULE connectionless downlink message which results in the portable part displaying 524 the received information.

In the case that the portable part 520 goes off-hook 525, i.e. the user answers using that portable part 520, the portable part 520 sends 531 the CC-SETUP-REQ message to the fixed part.

This behavior follows the procedure may be defined in ETSI Technical Specification TS 102 929 2.

The fixed part 510 will connect 530 the call and then send 532 a CC-CONNECT message to the portable part 520.

By the use of the ULE B-field paging mechanism, the restricted number of portable parts that can be registered on the fixed part can be raised from typically five to several hundred. The fixed part can then ring a selected number of portable parts, for example all the handsets or portable parts in one department in an enterprise scenario, or, by using the broadcast option, ring all portable parts that are registered. The scheme is generally still restricted to the first five portable parts to get a link or ten portable parts in case NBS (non-blind slot) is used and the link is an NB link.

A further benefit is that the fixed part can send a message to a portable part such as “call waiting” or indeed can send a message to all registered portable parts that each portable part would display. Emergency messages could be quickly and efficiently dispersed in this manner.

Using connectionless downlink

The fixed point can send to the portable parts the call indicator and additional information—information in addition to the call indicator.

The additional information can be included in a connectionless downlink broadcast.

The announcement for the connectionless downlink broadcast can be done by paging channels (for example- by using a B-Frame of a ULE dummy bearer).

The connectionless downlink broadcast can be announced few frames in advance.

The connectionless downlink allows messages to be broadcast from the DECT fixed point to one or more portable parts.

The portable parts are assigned an appropriate paging identifier prior to being paged on the channel. The portable parts search for this appropriate paging identifier at a predetermined cycle and within predefined frames.

The connectionless downlink paging is one-directional (FP to portable part only).

The connectionless downlink paging is unacknowledged (there is no return path, and the fixed part does not know whether a connectionless message was received by a portable part).

The connectionless downlink paging is secure (uses same CCM encryption as regular packets).

The connectionless downlink paging is inherently multi-cast (but could also be unicast if the paging address is only assigned to a single portable part.

The call indicator may occur on a certain frame, and the actual connectionless downlink broadcast on another frame.

The connectionless downlink broadcast may be included in a so-called additional information bearer that replaces the regular ULE dummy bearer.

The replacement of the dummy bearer information by the C/L downlink information may be allowed only every few frames. The additional information bearer may be allowed only every few frames (for example—once in each four frames) to avoid affecting system performance adversely.

The additional information may be included within the B-Field of the additional information bearer. A part of the B-field or the entire B-field may be allocated for the additional information.

The availability of connectionless data can be indicated up to three (an example only) frames earlier.

It should be noted that the call indicator can be included in a B-field of a ULE dummy bearer and that the B-field of the ULE dummy bearer does not include the additional information. The additional information is included in a frame that is located at a predefined time after the ULE dummy bearer. Alternatively—the location of the frame that includes the additional information may be indicated by the ULE dummy bearer. In this case the ULE dummy bearers are not replaced by an additional information bearer, the system can be more stable.

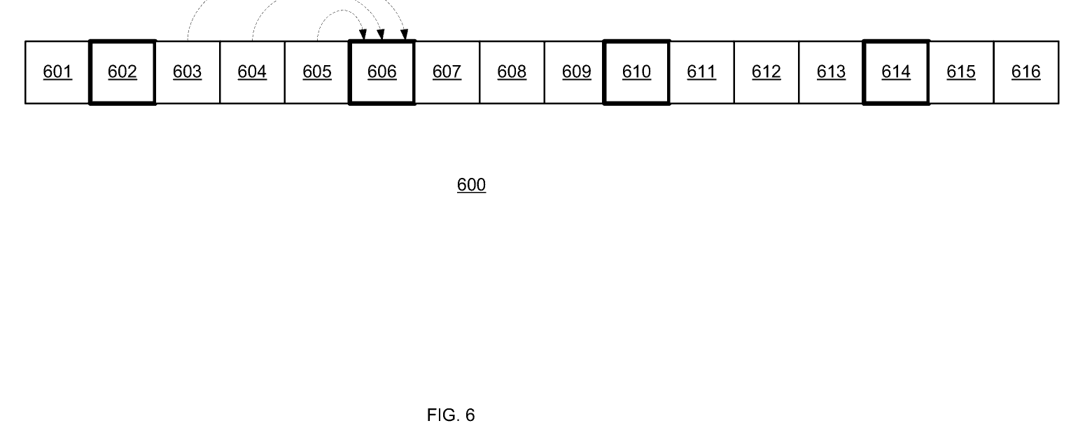

FIG. 6 illustrates a DECT multi-frame 600 that includes sixteen frames 601-616, wherein only the second, sixth, tenth and fourteenth frames 602, 606, 610 and 614 are additional information bearers.

Frames (for example up to three frames) that precede each additional information bearer may point to the information bearer.

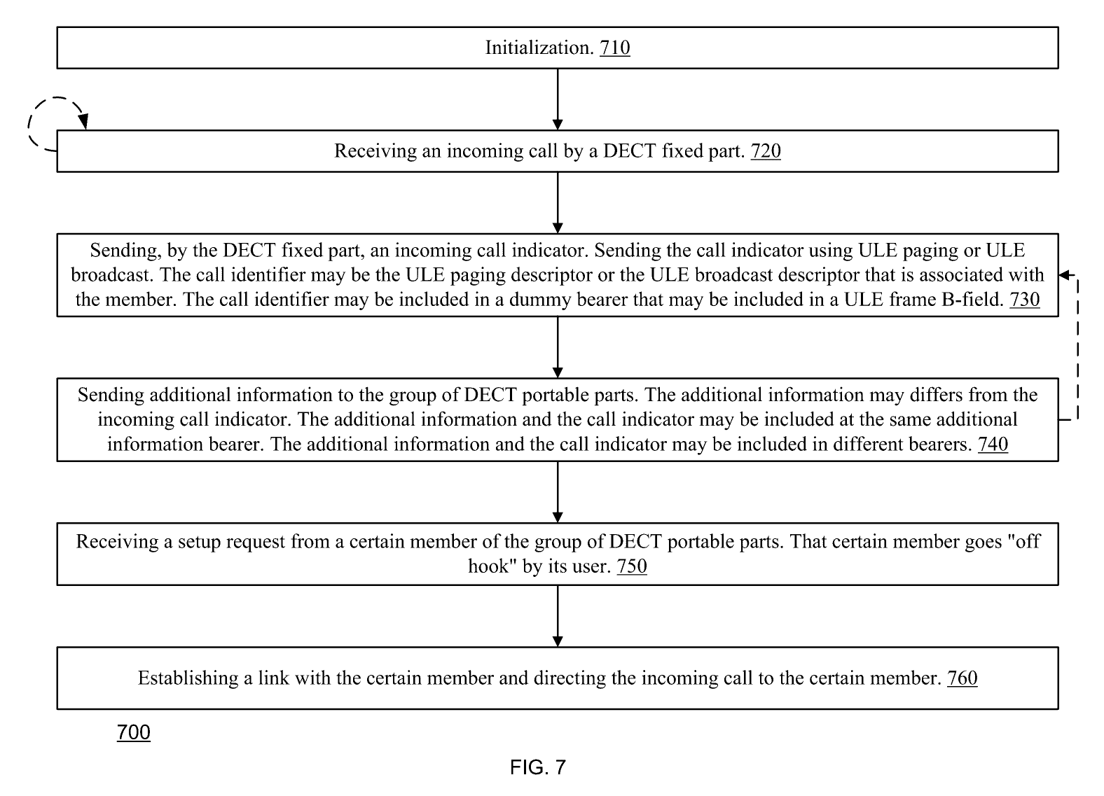

FIG. 7 illustrates method 700 according to an embodiment of the invention.

Method 700 may be executed by a fixed part such as the fixed part of FIG. 5.

Method 700 may start by an initialization step 710.

During step 710 the fixed part participates in a registration process or any other process during which each member of a group of portable parts is registered as a DECT ULE device (although the portable parts are not DECT ULE devices).

During step 710 the fixed part may provide each member (each portable part of the group) with a search window (DECT frame and a repetition rate) in which the member searches for a ULE paging descriptor (when using ULE paging) that is associated with the member or a ULE broadcast descriptor (when using ULE broadcasting) that is associated with the member.

Step 710 may be followed by step 720 of receiving an incoming call by a fixed part. Step 720 may be repeated for each incoming call.

Step 720 may be followed by step 730 of sending, by the fixed part, an incoming call indicator. The incoming call indicator may be received by various devices, including members of a group of portable parts that are monitoring transmissions from the fixed part according to the process defined during step 710.

Step 730 may include sending the call indicator using ULE paging or ULE broadcast.

The call identifier may be the ULE paging descriptor or the ULE broadcast descriptor that is associated with the member.

The call identifier may be included in a dummy bearer that may be included in a ULE frame B -field.

Step 730 may be executed without establishing a link with members of the group of portable parts.

Step 730 may be followed by step 740 of sending additional information to the group of portable parts. The additional information may differ from the incoming call indicator.

The additional information may include information that is displayed by the portable ports.

The additional information may be caller identifier (caller ID), a textual message, and any content to be displayer and/or processed by the portable parts.

The additional information and the call indicator may be included at the same additional information bearer. The additional information bearer differs from a ULE dummy bearer as it includes the additional information.

Frames that precede the additional information bearer may point to the additional information bearer.

Because the additional information bearer may be transmitted instead of the ULE dummy bearer there may be a tradeoff between the number of ULE dummy bearers and the number of the additional information bearers. Too many additional information bearers may introduce synchronization errors. A ratio of one additional information bearer per three ULE dummy bearers can be useful. Other ratios can also be provided.

Alternatively, the additional information and the call indicator are included in different bearers. The call indicator may be included in the ULE dummy bearer and the ULE dummy bearer may point to the location of the additional information.

Step 740 may include transmitting the additional information in any of the mentioned above bearers.

Step 730 and 740 may repeated multiple times—for example until one of the portable points is hung up, until a predefined time period expires or until reaching a predefined repetition value.

Step 740 may be followed by step 750 of receiving a setup request from a certain member of the group of portable parts. That certain member goes “off hook” by its user.

Step 750 may be followed by step 760 of establishing a link with the certain member and directing the incoming call to the certain member.

While the above description contains many specifics, these should not be construed as limitations on the scope, but rather as an exemplification of several embodiments thereof. Other variants are possible including, for examples variations additions or omissions to the detailed fields within the ULE B-Field and details of the message exchanges in the ULE Paging timing sequence.

Accordingly, the scope should be determined not by the embodiments illustrated, but by the claims and their legal equivalents.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for incoming call management, the method comprising:
receiving an incoming call by a digital enhanced cordless telecommunications (DECT) fixed point;
sending an incoming call indicator, using at least one out of ultra low energy (ULE) paging and ULE broadcast, by the DECT fixed point, to a group of DECT portable parts; wherein each member of the group of DECT portable parts was registered as a ULE device at the DECT fixed point; wherein the sending of the incoming call indicator is executed without establishing a link with members of the group of DECT portable parts;
receiving a setup request from a certain member of the group of DECT portable parts;
establishing a link with the certain member; and
directing the incoming call to the certain member.

2. The method according to claim 1 further comprising sending additional information to the group of group of DECT portable parts; and wherein the additional information differs from the incoming call indicator.

3. The method according to claim 2 wherein the additional information comprises a caller identifier.

4. The method according to claim 2 wherein the additional information comprises a textual message.

5. The method according to claim 2 wherein the additional information and the call indicator are included in a single information bearer.

6. The method according to claim 2 wherein the additional information and the call indicator are included in different bearers.

7. The method according to claim 2 wherein the sending of the additional information comprising using ULE contactless downlink.

8. The method according to claim 2 comprising transmitting, by the DECT fixed point, a sequence of bearers that comprises an additional information bearer and a dummy bearer.

9. The method according to claim 2 comprising repeating, multiple times, the sending of the incoming call indicator and the sending of the additional information.

10. The method according to claim 1 wherein the sending of the call indicator comprises sending a broadcast identifier or a paging identifier to the group of DECT portable parts.

11. The method according to claim 1 wherein the sending of the incoming call indicator comprising sending the call indicator within a B-field of a ULE dummy bearer.

12. A non-transitory computer readable medium that stores instructions that once executed by a digital enhanced cordless telecommunications (DECT) fixed point, causes the DECT fixed point to receive an incoming call; send an incoming call indicator, using at least one out of ultra low energy (ULE) paging and ULE broadcast, to a group of DECT portable parts; wherein each member of the group of DECT portable parts was registered as a ULE device at the DECT fixed point; wherein the sending of the incoming call indicator is executed without establishing a link with members of the group of DECT portable parts; receive a setup request from a certain member of the group of DECT portable parts; establish a link with the certain member; and direct the incoming call to the certain member.

13. A digital enhanced cordless telecommunications (DECT) fixed point that comprises a transceiver and a processor;
wherein the transceiver is configured to receive an incoming call by a DECT fixed point;
wherein the processor is configured to generate an incoming call indicator using at least one out of ultra low energy (ULE) paging resource and a ULE broadcast resource;
wherein the transceiver is configured to send the incoming call indicator to a group of DECT portable parts; wherein each member of the group of DECT portable parts was registered as a ULE device at the DECT fixed point;
wherein the DCET fixed point is configured to send the incoming call indicator without establishing a link with members of the group of DECT portable parts;
wherein the transceiver is configured to receive a setup request from a certain member of the group of DECT portable parts;
wherein the DECT fixed point is further configured to establish a link with the certain member and direct the incoming call to the certain member.

14. The DECT fixed point according to claim 13 wherein the transceiver is configured to send additional information to the group of group of DECT portable parts; and wherein the additional information differs from the incoming call indicator.

15. The DECT fixed point according to claim 14 wherein the additional information comprises a caller identifier.

16. The DECT fixed point according to claim 14 wherein the additional information comprises a textual message.

17. The DECT fixed point according to claim 14 wherein the additional information and the call indicator are included in a single information bearer.

18. The DECT fixed point according to claim 14 wherein the additional information and the call indicator are included in different bearers.

19. The DECT fixed point according to claim 14 wherein the transceiver is arranged to send the additional information by using ULE contactless downlink.

20. The DECT fixed point according to claim 14 wherein the transceiver is arranged to send a sequence of bearers that comprises an additional information bearer and a dummy bearer.

21. The DECT fixed point according to claim 14 that is arranged to repeat, multiple times, a sending of the incoming call indicator and a sending of the additional information.

22. The DECT fixed point according to claim 13 wherein the transceiver is configured to send a broadcast identifier or a paging identifier to the group of DECT portable parts.

23. The DECT fixed point according to claim 13 wherein the transceiver is configured to send the call indicator within a B-field of a ULE dummy bearer.
